(19) United States
(12) Patent Application Publication
(10) Pub. No.: US 2005/0007786 A1
(43) Pub. Date: Jan. 13, 2005

(54) Utility light-all purpose

(76) Inventors: Robert M. Currie, Dollard-Des-Ormeaux (CA); Eliot Sorella, Laval (CA)

Correspondence Address: Merek, Blackmon & Voorhees, LLC, 673 S. Washington St., Alexandria, VA, 22314, US

(21) Appl. No.: 10/858,054

(22) Filed: Jun. 2, 2004

Related U.S. Application Data
(63) Continuation-in-part of application No. 10/685,594, filed on Oct. 16, 2003.
(60) Provisional application No. 60/474,617, filed on Jun. 2, 2003.
(60) Provisional application No. 60/418,563, filed on Oct. 16, 2002.

(51) Int. Cl. F21V 17/02

(52) U.S. Cl. 362/321

(57) ABSTRACT

A utility light 10 is comprised of a flashlight shaped case 12 within which are the battery compartment 14, one or more solid-state illumination sources 16, electronic flashing and strobing circuit, an electrical tilt switch and an electrical switching arrangement 18. The electrical switching arrangement 18 will provide a means to control the light source, the electrical flashing circuit, the electrical strobe light circuit, and the tilt switch circuit. The device replaces a standard fluorescent light source for durability and other efficiencies.

This application claims the benefit of U.S. Provisional Application 60/474,617 filed Jun. 2, 2003, and to U.S. Patent Application Ser. No. 10/685,594 filed Oct. 16, 2003, which are both hereby incorporated by reference.

### BACKGROUND OF THE INVENTION

A. Field Of The Invention

The present invention relates to a multipurpose utility light using light emitting diodes as a replacement for conventional fluorescent lights.

B. Description Of The Prior Art

There are many occasions when camping at night that the need arises for a light source that can illuminate a 360 degree area such as the inside of a tent or an eating area. Campers always bring a flashlight, but not always a risky flame based 360-degree light source fueled by flammable liquids or gas. A portable, safe, utility light in a night camping environment that could function as either or both a beam type flashlight and a 360-degree area light would be very desirable.

This invention seeks to satisfy these many identified uses with a single all purpose utility light.

None of the above inventions and patents, taken either singly or in combination, is seen to describe the instant invention as claimed.

### SUMMARY OF THE INVENTION

In today's ever-changing world a need has arisen for a multi-purpose utility light that is new and unique. Such a light would operate first as a conventional flashlight illuminated by a super bright light emitting diode with a rechargeable battery.

Second, this all purpose light would be able to light as a fluorescent light without being a true fluorescent light.

Third, this new light would be able to flash at a predetermined or variable rate and flash brightly as a quick impulse strobe light.

Fourth, this light would have an optically conductive mounting case that would be installed inside the cover of pick up truck caps and tool chests. The light would contain a tilt switch that would switch the light on and off when the pick up cap or tool chest cover is opened and closed. The optically conductive case would pass light in 360 degrees of direction allowing wide area illumination of the truck bed or tool chest interior.

Fifth this light would be water resistant and would float in an upright position.

While floating in an upright position the 360 degree sidelight would illuminate a horizontal area of water proximate the light and a beam of light would be directed upward in a random manner as the light moved erratically while floating. The light could be switched to the strobe light mode and be visible while floating in the water from very far away either on the water or from the air. Such a combination of illumination at night in water would be very visible from afar and therefore constitute a new and unique water safety device.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a circuit diagram of the electrical switches according to a preferred embodiment of the invention.

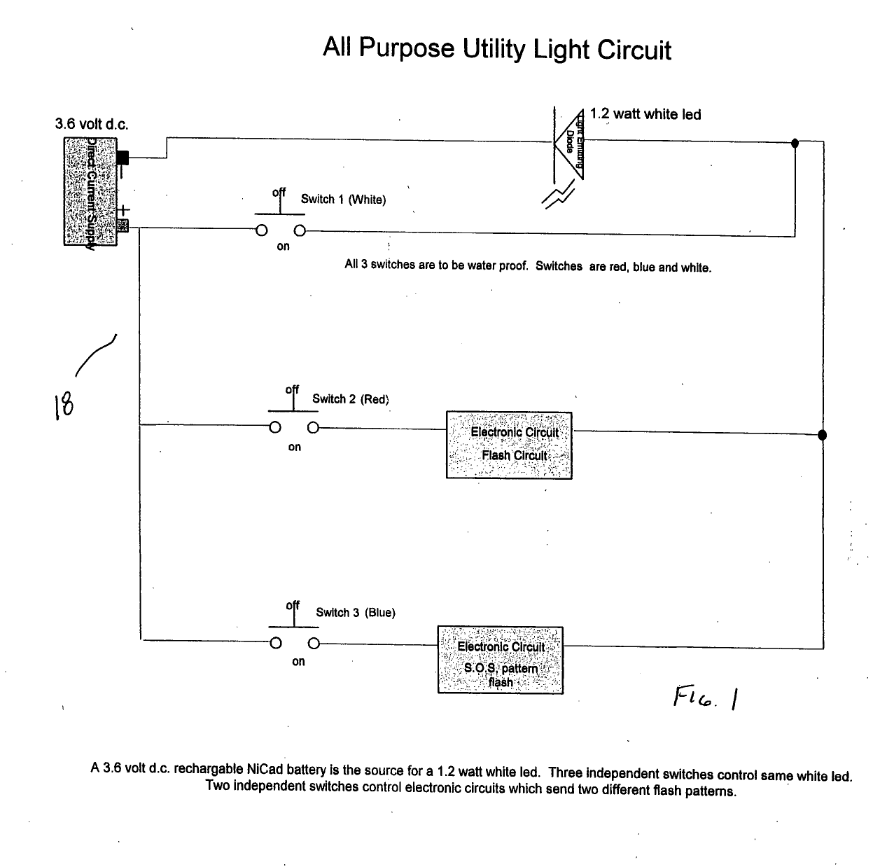

FIG. 2 is a plan view of the utility light according to a preferred embodiment of the invention.

FIG. 3 is an environmental view of the utility light installed on a tool chest.

Similar reference characters denote corresponding features consistently throughout the attached drawings.

### DETAILED DESCRIPTION OF THE PREFERRED EMBODIMENT(S)

The present invention is to a utility light that will satisfy the needs of pick up truck owners who have cargo area caps or tool chests without internal lighting, boaters, campers, night fishermen, and others who need a combination type of light providing either separately or in combination, a beam of light, a 360 degree light, a flashing or strobing light, or a tilt switch activated light.

This utility light 10 is comprised of a flashlight shaped case 12 within which are the battery compartment 14, one or more solid-state illumination sources 16, electronic flashing and strobing circuit, an electrical tilt switch and an electrical switching arrangement 18.

The electrical switching arrangement 18 will provide a means to control the light source, the electrical flashing circuit, the electrical strobe light circuit, and the tilt switch circuit.

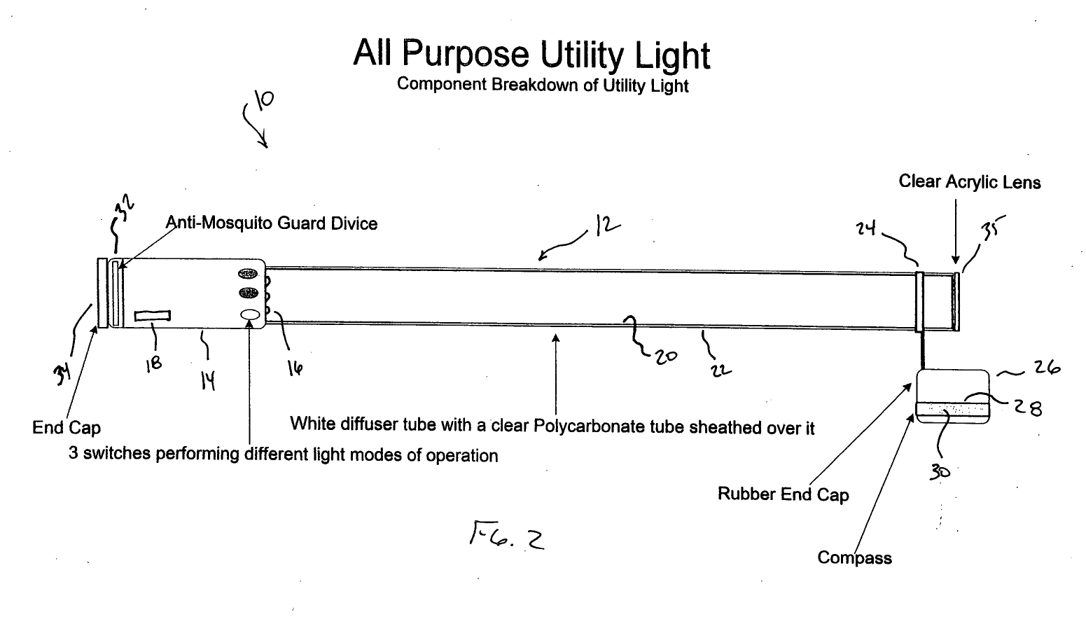

A hollow tube shaped attachment 20 made of a clear or opaque optically conductive material infused with special brighteners (not shown) that cause the tube to radiate sidelight uniformly around and along its surface is screw thread attached to the front of the utility light. This hollow tube shaped attachment is tightly encased in an optically conductive clear polycarbonate sleeve, sheath or tube 22. This optically clear sheath or tube also has a clear end cap 24 making the complete tube attachment watertight when attached to the battery case by threading the cap to the tube or similar attachment means. The sheath 22 also provides damage protection for the inner light diffusing material. A screw on cap attachment 26 with a full reflective inner surface 28 is attached to the outer front end of the utility light when maximum side light or simulated neon light is desired, and is stored as a screw on back cover when a conventional flashlight beam of light is needed. With this cap 26 attached, end light from the source is reflected back into the tube causing maximum radiated sidelight. When the cap is removed as in FIG. 2, much of the source light is directed out of the tube as a conventional flash light beam. A lens 35 may be provided to help focus or direct the light exiting the end of the tube.

Optionally the cap may include other devices such as a compass 30 for direction finding. The battery housing may also be electrically connected to an ultrasonic mosquito repeller 32 and sealed by a resilient end cap 34.

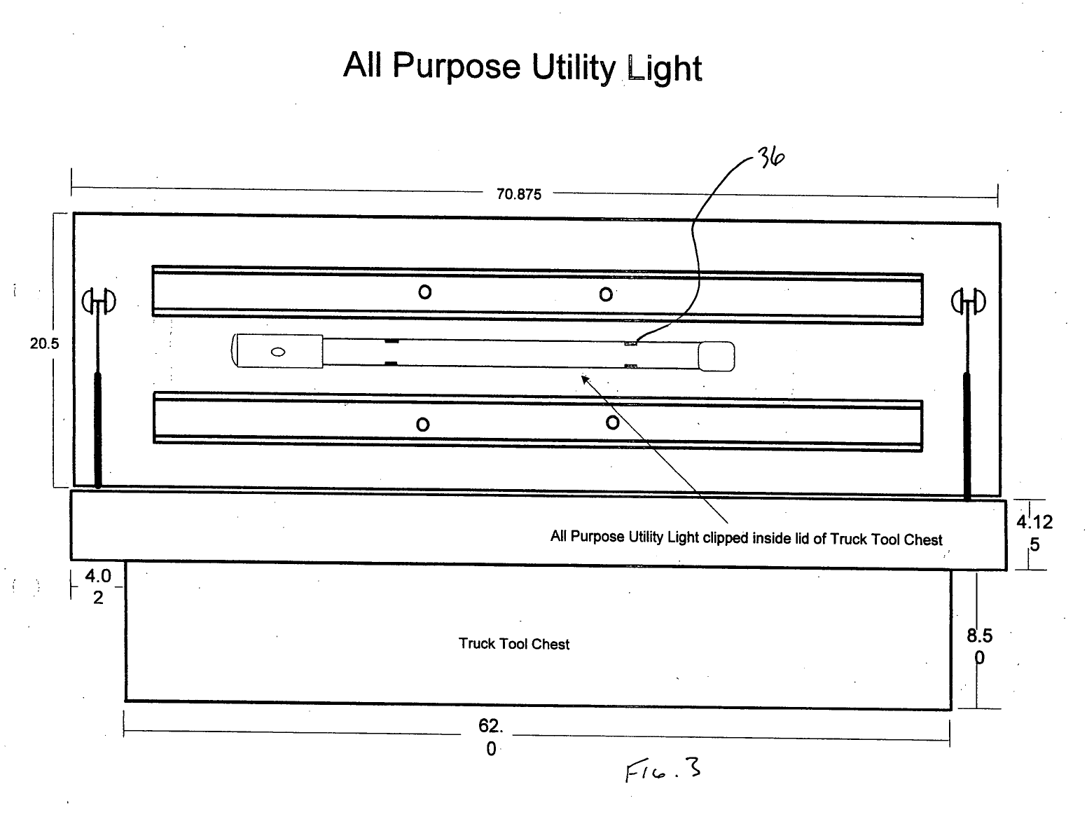

An optically conductive mounting case 36 made of clear acrylic or other clear plastic type material is provided with means for attaching to the inside top cover of pick up cargo area covers, such as the Taunneau Cover (not shown) or to the inside cover of truck mounted tool chests 40 (FIG. 3). The utility light is switched to operate in the tilt switch mode before placing it in the optically conductive case, such that when the chest is opened, the light is illuminated.

A rechargeable battery provides electrical power for the illumination source of this utility light. The complete unit is water resistant and will float in a vertical with the heavier battery portion 14 at the lowermost position with the wand and cover uppermost. The end cap 34 may be weighted to ensure proper floating position of the light. It is to be understood that the present invention is not limited to the sole embodiment described above, but encompasses any and all embodiments within the scope of the following claims.

1. A utility light with a tube shaped attachment to the light emitting end that will selectively operate in five different modes:
a. in a first mode said utility light will generate a conventional end beam of light;
b. in a second mode said utility light will illuminate in 360 degrees relative to the longitudinal direction of the utility light case;
c. in a third mode said utility light will operate when electrical connectivity is established by an electrical tilt switch;
d. in a fourth mode said utility light will illuminate at a predetermined flash rate or at an adjustable flash rate;
e. in a fifth mode said utility light will illuminate in a strobe light mode;

2. The utility light of claim 1, further comprising an illumination source having one or more light emitting diodes of white or any other color;
(a) said light emitting diodes may be strobe diodes or strobed light emitting diodes, or light emitting diodes flashed on and off at any rate in any sequence;
(b) said second mode of operation is maximized by attaching an end cap with a fully reflective inner surface to the light emitting end of said utility light;
(c) said end cap accessory may be stored as a screw on attachment to the non light emitting end of said utility light;

3. The light of claim 1, wherein the hollow tube shaped attachment is made of optically transmissive material and infused with special brighteners and is screw thread attached to the light emitting end of said utility light;
a. said attachment is encased in a tight fitting, closed end sleeve, sheath, or tube made of optically conductive clear polycarbonate material;
b. said closed end sleeve attachment is water resistant when attached to said utility light of claim 1 causing said utility light to be buoyant and float partially submerged in a vertical position.
